(19) United States
(12) Patent Application Publication
(10) Pub. No.: US 2005/0214426 A1
(43) Pub. Date: Sep. 29, 2005

(54) Synergistic effects of tagatose and oligosaccharides on mouthfeel and creaminess in dairy products

(76) Inventor: Katrin Saelzer, Gross-Krotzenburg (DE)

Correspondence Address: PROPAT, L.L.C., 425-C SOUTH SHARON AMITY ROAD, CHARLOTTE, NC, 28211-2841, US

(21) Appl. No.: 10/812,204

(22) Filed: Mar. 29, 2004

(51) Int. Cl. A23L 1/236

(52) U.S. Cl. 426/548

(57) ABSTRACT

The present invention provides fat replacement compositions imparting advantageous organoleptic properties to reduced calorie foodstuffs. The fat replacement compositions generally include a mixture of tagatose and at least one indigestible oligosaccharide. The instant fat replacement compositions have a synergistic effect on the organoleptic properties of the resulting reduced calorie foodstuffs, particularly mouthfeel and creaminess. Accordingly, lesser amounts of the instant reduced-fat compositions may be incorporated into the reduced calorie foodstuffs.

### FIELD OF THE INVENTION

The present invention generally relates to reduced calorie foodstuffs. More particularly, the present invention relates to fat replacement compositions which may be included within reduced calorie foodstuffs to provide advantageous organoleptic properties.

### BACKGROUND OF THE INVENTION

The market for reduced calorie foodstuffs is growing, based on the increasing health consciousness of consumers. However, taste quality remains one of the most important decision criterions for consumers, regardless of the caloric reduction. More specifically, consumers are generally unwilling to accept any compromise within the taste quality of reduced calorie foodstuffs.

Two common approaches by which manufacturers reduce calories within foodstuffs are to lower either the fat or the sugar content of the food. A reduction in the fat content is generally considered a more effective way of reducing calories, due to the higher caloric value of fat compared to sugar, 9.3 kcal/g versus 4.2 kcal/g, respectively. Such reductions in the fat content of food are problematic, however. Fat plays an important role in the organoleptic properties of foodstuffs, specifically the taste properties. Mouthfeel and creaminess are two particular taste properties that are typically detrimentally effected by fat reduction. The detrimential impact to mouthfeel and creaminess is especially acute within dairy products, such as yogurt, fermented milk drinks, flavoured milk, ice cream, cream and the like.

Consequently, attempts have been made to develop effective fat-substitutes that mimic the organoleptic properties of fat, particularly the mouthfeel and creaminess of fat, within reduced calorie foods. Franck reports that soluble fibers, such as inulin and oligofructose, may help address taste issues within low-fat foods [Franck. A, British journal of Nutrition (2002), 87(2), p 287-291]. Although indicating improved taste, there remains room for improvement in matching the organoleptic properties of full fat foods. Further, although inulin and oligofructose represent a caloric reduction in comparison to the fats they replace, they are not calorie free. Specifically, both inulin and oligofurctose have a caloric value of 1.5 kcal/g, which contributes to the overall calorie value of the resulting foodstuffs. Oligosaccharides, such as inulin and oligofructose, are also problematic as they are known to potentially cause digestive problems and flatulence.

Further agents have been investigated as fat-replacements. Tagatose is generally known as a reduced calorie food sweetening and bulking agent. For example, Anderson discloses in WO 99/34689 that tagatose improves the taste properties, such as sweetness intensity and sweetness taste quality, of reduced sugar or sugar free beverages when used in combination with high intensity sweeteners. Lee describes beneficial effects of combinations of tagatose with sugar alcohols such as erythritol on taste profile of sugar free and low-sugar beverages and food products in U.S. 02/0197371 and WO 02/87358.

However, although generally considered as a sweetener or bulking agent, a technical publication by Arla Corporation notes that tagatose may have a beneficial impact on the mouthfeel of dairy products. Aria notes that the improvements in mouthfeel within soft drinks may be due to a reduction in the aftertaste and/or astringency of additional high intensity sweeteners used in combination with the tagatose. Although noting improvements in taste, there remains a need for improvement in matching the organoleptic properties of full fat foods. Furthermore, similar to inulin and oligofructose, tagatose has a caloric value of 1.5 kcal/g, likewise contributing to the overall caloric value of the resulting foodstuffs.

Accordingly, a need remains in the art to further reduce the calorie value of low-fat foodstuffs without affecting the overall organoleptic properties of the food. A need also remains in the art to improve the organoleptic properties, particularly the mouthfeel and creaminess, of known low-fat foodstuffs.

### BRIEF SUMMARY OF THE INVENTION

The present invention provides further reduced calorie low-fat foodstuffs, without significant sacrifice to the overall organoleptic properties of the resulting product, and particularly the taste. In alternative embodiments, improved organoleptic properties, particularly the mouthfeel and creaminess, are provided for low-fat foodstuffs in comparison to many conventional low-fat compositions.

As used herein, the term “taste” refers to the sum of all organoleptic characteristics perceived in the mouth during eating, chewing or swallowing the product. Exemplary organoleptic characteristics include sweetness, acidity, flavour and mouthfeel. The term “mouthfeel” as used herein describes all tactile observations related with the texture and sensation of texture in the mouth, including the characteristic “creaminess” which usually refers to the mouthfeel of fat or cream.

The present invention is directed to fat replacement compositions that include an effective amount of tagatose, along with an effective amount of at least one indigestible oligosaccharide. The fat replacement compositions of the invention provide a mouthfeel to a foodstuff that is superior in comparison to the mouthfeel induced within foodstuffs incorporating tagatose alone. More specifically, the instant fat replacement compositions provide at least about 10% more creaminess to a foodstuff in comparison to the creaminess induced within foodstuffs incorporating a comparable amount of tagatose alone.

The present invention is further directed to foodstuffs incorporating the fat replacement compositions of the invention, as well as methods by which to form the instant fat replacement compositions and reduced calorie foodstuffs.

Most surprisingly, the instant fat replacement compositions exhibit a synergistic effect in improving the mouthfeel, particularly the creaminess, of low fat foods, in comparison to the use of tagatose or oligofructose alone. Foodstuffs incorporating the instant fat replacement compositions exhibit an overall taste profile that is superior to foods including tagatose or oligofructose alone, for example.

### DETAILED DESCRIPTION OF THE INVENTION

Fat replacement compositions in accordance with the invention generally include tagatose and at least one indigestible oligosaccharide.

Tagatose, also referred to in the art as D-tagatose or β-D-tagatose, is the common name for a particular sugar enantiomer having the molecular formula C₆H₁₂O₆. Tagatose is commercially available as GAIO® tagatose from Aria Food Ingredients, Denmark. In alternative embodiments, Applicants hypothesize that other undigestible sugars, such as any left-handed enantiomeric sugar, may be used in lieu of tagatose.

Tagatose may be included within the fat replacement compositions in any amount effective in imparting suitable organoleptic properties to the resulting foodstuff. The tagatose is advantageously included within the present fat replacement compositions in non-limiting exemplary amounts ranging from about 10 to 90 weight percent, based on the weight of the fat replacement composition (“bowfrc”), such as amounts ranging from about 15 to 75 weight percent (bowfrc), specifically from 30 to 70 weight percent (bowfrc), and more specifically from about 45 to 55 weight percent (bowfrc). It being understood that the total amount of tagatose and ndo equals 100 weight percent.

As noted above, the present fat replacement compositions further include at least one indigestible oligosaccharide. As used herein, oligosaccharides are defined as carbohydrates that may contain any number of monosaccharide units, such as from 2 to 60 monosaccharide units.

The term “indigestible oligosaccharide” as used herein generally means either (a) an oligosaccharide that a human's digestive enzymes are incapable of converting to glucose or other simple sugars or (b) an oligosaccharide which resists conversion to glucose or other simple sugars by human's digestive enzymes in comparison to conventional dietary fibers.

Applicant hypothesizes that a wide range of exemplary indigestible oligosaccharides may be suitable for use within the present fat replacement compositions, including fructooligosaccharides, xylooligosaccharides, alpha glucooligosaccharides, trans galactosyl oliosaccharides, soybean oliosaccharides, lactosucrose, polydextrose and the like, and mixtures thereof. In advantageous embodiments, the oligosaccharide is a fructooligosaccharide.

Fructoolioscaccharides, which may also be referred to as fructan carbohydrates, are well known in the art. Advantageous non-limiting exemplary fructooligosaccharides which may be included within the fat replacement compositions include inulin, oligofructose, and mixtures thereof. Exemplary weight ratios for mixtures of inulin and oligofructose range from about 1:10 to 10:1 (weight inulin to weight oligofructose), with a weight ratio of 1:1 preferred.

As used herein, inulin generally refers to a type of fructooligosaccharide having a degree of polymerization of from about 2 to 60 molecules, although inulin having a higher degree of polymerization may be useful, as well. Inulin may be derived from a number of sources, including chicory root. Oliogofructose is generally known in the art as an inulin fraction having a lower degree of polymerization, typically from about 2 to 9. Oligofructose is usually isolated from inulin by partial enzymatic hydrolysis, as known in the art. The term fructooligosaccharide is often used as a synonym for oligofructose or as a product similar to oligofructose which is produced via enzymatic conversion of sucrose. Inulin and oligofructose are commercially available from Raffinerie Tirlemontoise s.a., Brussel as Raftilin® or Raftilose® respectively. Fructooligosaccharides is commercially available from Cerestar as Actilight®.

The indigestible oligosaccharide may be included within the fat replacement compositions in any amount effective in imparting suitable organoleptic properties to the resulting foodstuff. The indigestible oliogosaccharide is advantageously included within the present fat replacement compositions in non-limiting exemplary amounts ranging from about 10 to 90 weight percent (“bowfrc”), such as amounts ranging from about 25 to 85 weight percent (bowfrc), particularly from 30 to 70 weight percent (bowfrc), and more specifically from about 45 to 55 weight percent (bowfrc). It being understood that the total amount of tagatose and indigestible oligosaccharide combined equals 100 weight percent (bowfrc).

In particularly advantageous embodiments of the invention, the foodstuff is sugar free or has reduced sugar content. To replace sugar or caloric sweeteners partly or completely, high intensity sweeteners may be included within the foodstuff. Exemplary high intensity sweeteners include acesulfame-K, aspartame, acesulfame-aspartame salt, cyclamate, saccharine, sucralose, NHDC, thaumatin, stevioside, neotame, brazzein, and mixtures thereof. In particularly beneficial aspects of such embodiments, combinations of high intensity sweeteners may be used, such as combinations of two, three or four high intensity sweeteners selected from the group of acesulfame K, aspartame, sucralose, neotame, cyclamate and saccharine. Preferred high intensity sweetener mixtures for use in the present invention include acesulfame K/aspartame mixtures, acesulfame K/sucralose mixtures, acesulfame K/aspartame/sucralose mixtures and acesulfame K/neotame mixtures.

Persons skilled in the art can readily determine suitable amounts, combinations and weight ratios of high intensity sweeteners or high intensity sweetener combinations necessary to achieve a particular sweetness intensity and taste profile for a given food application.

The present fat replacement compositions may advantageously be incorporated into any liquid or semi-soft foodstuff or any solid foodstuff formed from more than one component. Exemplary foodstuffs include dairy products, desserts, pre-packaged foods, condiments and the like. In advantageous embodiments, the foodstuff is a dairy product. As used herein, “dairy products” refers to raw and processed or manufactured milk and milk-derived products. These are usually from cows (bovine) but could also be from goats, sheep, reindeer, and water buffalo. Non-limiting exemplary dairy products include plain yoghurt, flavoured yoghurt, fruit-yoghurt, flavoured milk drinks, fermented milk drinks with or without fruit preparation or flavouring, any curd cheese or soft cheese, ice cream, milk chocolate, cream or cream based desserts.

The instant fat replacement compositions can be advantageously present within the foodstuff in any amount effective in imparting beneficial organoleptic properties to the resulting foodstuff. The fat replacement compositions may be included within foodstuffs in non-limiting exemplary amounts ranging from about 0.2 to 5.0 weight percent, based on weight of the foodstuff (“bowfs”). In advantageous embodiments, the fat replacement compositions can be present in foodstuffs ranging from about 0.5 to 2.0 weight percent (bowfs).

One especially advantageous foodstuff within the scope of the present invention is low-fat yoghurt. As a specific example, for low-fat yoghurt with no added sugar, the instant fat replacement composition would generally include a mixture of tagatose and either inulin or oligofructose. The instant fat replacement composition would typically be added to such sugar-free low-fat yoghurts in a concentration of about 0.5 to 1% by weight (bowfs).

As used herein, the term “low-fat” or “reduced calorie” means compositions having a reduced number of calories or fat compared with full-calorie or full-fat counterpart respectively. The term “full-fat” as used herein refers to the fat content of the equivalent product manufactured from whole milk or cream, which would be for example yoghurt with around 3.5 weight percent fat, milk drinks with 3.5 weight percent fat or cream-based products with between about 10 and 30 weight percent fat. The term “fat-free” means compositions having only an insignificant amount of fat. For example, yoghurts containing about 0.3 weight percent or less of fat would be considered “fat-free” yoghurt.

The instant fat replacement compositions and foodstuffs in accordance with the invention are formed by simply mixing the various components together. For example, the fat replacement compositions are formed by either (a) combining the tagatose and at least one oligosaccharide together and mixing or (b) by adding the tagatose and at least one oligosaccharide separately to the foodstuff and then mixing. The mixing process employed may be any suitable mixing technique known in the food industry. The mixing may be done with either dry products or with solutions of the tagatose and/or at least one oligosaccharide and/or foodstuff, or combinations thereof. The reduced-calorie sweetener compositions may be incorporated directly into the foodstuffs before, after or simultaneous with the addition of the fat replacement composition or its components, using techniques known in the art.

Quite unexpectedly, Applicant found that the instant fat replacement compositions impart a synergetic effect in terms of mouthfeel, particularly creaminess, especially when used in fat-free or low-fat dairy products. Therefore, a significantly reduced amount of the instant fat replacement compositions can be incorporated into foodstuffs to produce organoleptic effects comparable to foodstuffs containing traditional amounts of many conventional fat replacers (such as tagatose or oligofructose alone). Furthermore, foodstuffs incorporating approximately the same amounts of the instant fat replacement compositions as are used with conventional fat replacers exhibit superior organoleptic properties than heretofore known within reduced fat foodstuffs formed from the several of the individual components alone. More particularly, foodstuffs incorporating the instant fat replacer compositions in the amounts normally used with conventional fat replacers actually have a better taste than foodstuffs incorporating either tagatose or oligofructose alone.

In addition to economic advantages, an essential benefit of the instant fat replacement composition is that the total amount of tagatose and oligosaccharides in the foodstuff can be significantly reduced to produce the same level of creaminess, resulting in a significant reduction in the caloric value of the overall foodstuff. More particularly, the instant fat replacement compositions allow the total amount of tagatose and oligosaccharides in the foodstuff to be reduced by 10% or more, preferably by 25% or more, such as by 30% or more, while retaining the same or substantially the same creaminess within the resulting foodstuff.

A further advantage of the instant fat replacement compositions is the reduced amount of indigestible oligosaccharides consumed by the end-user. As noted earlier, indigestible oligosaccharides are known to potentially cause digestive problems and flatulence.

The invention is further illustrated by the following, non-limiting, examples.

### EXAMPLES

### Comparative Examples 1 Through 3 and Example 1

Comparison of Creaminess of Yoghurts with Different Fat Content:

Artificially sweetened yoghurts with having a fat content of 1.5% (and no fat replacers) and 0.1% fat (with fat replacers) were compared sensorically. The objective was to describe and rank the samples in terms of creaminess and mouthfeel. Formulations of the yoghurts and results are described in Table 1.

TABLE 1

| | Comp. Ex. 1 | Comp. Ex. 2 | Comp. Ex. 3 | Example 1 |
|---|---|---|---|---|
| ACK¹ mg/100 g | 9.9 | 8.7 | 9.3 | 9.1 |
| Apm² | 19.3 | 16.9 | 18.1 | 17.7 |
| mg/100 g | | | | |
| Tagatose | — | 0.5 | — | 0.25 |
| g/100 g | | | | |
| Oligofructose | — | — | 0.5 | 0.25 |
| g/100 g | | | | |
| Fat content | 1.5 | 0.1 | 0.1 | 0.1 |
| of Yoghurt % | | | | |
| Sensory | Typical for | Sweetness | Sweetness | Sweetness |
| description | sweetened | comparable to | comparable, | comparable, |
| | yoghurt, slightly | standard, | mouthfeel | mouthfeel |
| | acidic, some | typical for fat | between | close to |
| | drying and slightly | free yoghurt, | standard and | standard, |
| | astringent | thin mouthfeel | Test 1.1 | creamy texture, |
| | aftertaste | | | Preferred |
| | | | | sample |

¹ACK is acesulfame K.
²Apm is aspartame.

As shown in Table 1, addition of 0.5% of a 1:1 mixture of tagatose and oligofructose to yoghurt having only of 0.1% fat gives a comparable creaminess and mouthfeel to a yoghurt containing 1.5% fat. In contrast, the addition of the same amount of the individual components, i.e. tagatose and oligofructose alone, showed only a limited improvement in mouthfeel. Surprisingly, the sample containing the fat replacement composition in accordance with the invention (Example 1 containing a combination of tagatose and oligofructose) was preferred in terms of creaminess even over the sample with 1.5% fat.

### Comparative Examples 4 and 5 and Examples 2 Through 6

Comparing Yoghurts with Different Concentration of Tagatose and/or Oligofructose

Artificially sweetened yoghurts with 0.3% fat content were prepared using the formulations provided in Table 2. The samples were served with random coded numbers to the panellists and were ranked by the testers in terms on creaminess with “1” being the best sample.

TABLE 2

| | C. Ex. 4 | C. Ex. 5 | Ex. 2 | Ex. 3 | Ex. 4 | Ex. 5 | Ex. 6 |
|---|---|---|---|---|---|---|---|
| ACK¹ | 8.7 | 9.5 | 9.1 | 9.2 | 9.3 | 9.4 | 9.5 |
| mg/100 g | | | | | | | |
| Apm² | 16.9 | 18.5 | 17.7 | 17.9 | 18.1 | 18.3 | 18.5 |
| mg/100 g | | | | | | | |
| Tagatose | 1.0 | — | 0.5 | 0.45 | 0.375 | 0.325 | 0.25 |
| g/100 g | | | | | | | |
| Oligo- | — | 1.0 | 0.5 | 0.45 | 0.375 | 0.325 | 0.25 |
| fructose | | | | | | | |
| g/100 g | | | | | | | |
| Ranking | 5 | 4 | 1 | 2 | 3 | 5 | 6 |

¹ACK is acesulfame K.
²Apm is aspartame.

As shown in Table 2, only 0.65% of fat replacement compositions in accordance with the invention are required to achieve the same effect in mouthfeel as 1% tagatose alone. As further shown in Table 2, only approximately 0.7% of fat replacement compositions in accordance with the invention are required to achieve the same effect as 1% oligofructose alone. Accordingly, 1:1 mixtures of tagatose and oligofructose offer around 30% more creaminess than either of these substances added alone.

### Comparative Examples 6 and 7 and Examples 7 Through 11

Comparing Yoghurts with Different Concentrations of Tagatose and/or Inluin

Artifically sweetened yoghurts with 0.3% fat were prepared using the formulations of Table 3, which incorporate inulin rather than oligofructose. Sensory description and ranking in terms of creaminess was done by a trained panel. Table 3 also summarises the corresponding results.

TABLE 3

| | C. Ex. 6 | C. Ex. 7 | Ex. 7 | Ex. 8 | Ex. 9 | Ex. 10 | Ex. 11 |
|---|---|---|---|---|---|---|---|
| ACK¹ | 8.7 | 9.8 | 9.25 | 9.3 | 9.4 | 9.5 | 9.6 |
| mg/100 g | | | | | | | |
| Apm² | 16.9 | 19.0 | 18.0 | 18.1 | 18.3 | 18.5 | 18.7 |
| mg/100 g | | | | | | | |
| Tagatose | 1.0 | — | 0.5 | 0.45 | 0.375 | 0.325 | 0.25 |
| g/100 g | | | | | | | |
| Inuline | — | 1.0 | 0.5 | 0.45 | 0.375 | 0.325 | 0.25 |
| g/100 g | | | | | | | |
| Ranking | 3 | 1 | 1 | 2 | 4 | 5 | 6 |

¹ACK is acesulfame K.
²Apm is aspartame.

As shown in Table 3, mixtures of inulin and tagatose again exhibited synergistic effects on improved creaminess. In the examples provided above, between 0.9 and 0.75% of a mixture of inuline and tagatose are necessary to achieve the same improvement in mouthfeel as with 1% tagatose. Consequently, the instant fat replacement compositions impart about 10% or more creaminess, more particularly between 10 to 25% more creaminess, than tagatose alone.

### Comparative Examples 8 and 9 an Examples 12 Through 16

Comparing Yoghurts with Different Mixtures of Oligofructose and Tagatose

Artifically sweetened yoghurts with 0.3% fat were prepared using the formulations of Table 4. Sensory description and ranking in terms of creaminess was done by a trained panel. Table 4 also summarises the corresponding results

TABLE 4

| | C. Ex. 8 | C. Ex. 9 | Ex. 12 | Ex. 13 | Ex. 14 | Ex. 15 | Ex. 16 |
|---|---|---|---|---|---|---|---|
| ACK¹ | 9.9 | 8.7 | 8.8 | 8.9 | 9.1 | 9.25 | 9.4 |
| mg/100 g | | | | | | | |
| Apm² | 19.3 | 16.9 | 17.2 | 17.5 | 17.7 | 18.0 | 18.3 |
| mg/100 g | | | | | | | |
| Tagatose | | 1.0 | 0.83 | 0.66 | 0.5 | 0.34 | 0.17 |
| g/100 g | | | | | | | |
| Oligofructose | | | 0.17 | 0.34 | 0.5 | 0.66 | 0.83 |
| g/100 g | | | | | | | |
| Sensory | Thin, | Creaminess | Creaminess | Significant | Very good | Creaminess, | Very |
| description | slightly | slightly | comparable | improved | mouthfeel, | comparable | creamy, |
| | acidic, | improved | to C. Ex. 9 | creaminess, | full, | to | but teeth |
| | teeth | over | (4.1), slightly | slicky | creamy | Ex 14 | covering, |
| | covering | comparison, | astringent | surface | | (4.4) | less |
| | | slick | | | | | yoghurt |
| | | surface, | | | | | flavour |
| | | slightly teeth | | | | | |
| | | covering | | | | | |
| Ranking | | 4 | 4 | 2 | 1 | 1 | 3 |

¹ACK is acesulfame K.
²Apm is aspartame.

As shown in Table 4, the synergistic effects in improving mouthfeel using the instant fat replacement compositions was seen over wide rage of blend ratios, although there were differences in intensity between the ratios. Nearly all mixtures gave a better mouthfeel and higher creaminess compared to the use of tagatose alone, however.

As illustrated above, mixtures according to the invention improve the mouthfeel and creaminess of low fat food, especially dairy products, so that products using these combinations taste like comparable products with a higher fat content. It was altogether unexpected that from about 10 to 30% less of the instant fat replacement composition is necessary in comparison to tagatose or oligofructose alone. By using the fat replacement compositions of the invention the added calories are thus minimised, due to its synergistic effects.

Additional advantages, features and modifications will readily occur to those skilled in the art. Therefore, the invention in its broader aspects is not limited to the specific details and representative devices, shown and described herein. Accordingly, various modifications may be made without departing from the spirit or scope of the general inventive concept as defined by the appended claims and their equivalents.

As used herein and in the following claims, articles such as “the”, “a” and “an” can connote the singular or plural.

All documents referred to herein are specifically incorporated herein by reference in their entireties.

1. A fat replacement composition comprising
an effective amount of tagatose and
an effective amount of at least one indigestible oligosaccharide,
said fat replacement composition providing at least about 10% more creaminess to a foodstuff in comparison to the creaminess induced within foodstuffs incorporating a comparable amount of tagatose alone.

2. A composition according to claim 1, wherein said tagatose is present in an amount ranging from about 15 to 75 weight percent, bowfrc.

3. A composition according to claim 1, wherein said indigestible oligosaccharide comprises at lest one member selected from the group consisting of fructooligosaccharides, xylooligosaccharides, alpha glucooligosaccharides, trans galactosyl oliosaccharides, soybean oliosaccharides, lactosucrose and polydextrose.

4. A composition according to claim 1, wherein said indigestible oligosaccharide is present in an amount ranging from about 25 to 85 weight percent, bowfrc.

5. A composition according to claim 1, wherein said indigestible oligosaccharide is fructooligosaccharide.

6. A composition according to claim 1, wherein said fructooligosaccharide is at least one of either inulin or oligofructose.

7. A reduced calorie foodstuff comprising a fat replacement composition,
said fat replacement composition comprising
an effective amount of tagatose and
an effective amount of at least one indigestible oligosaccharide,
said fat replacement composition providing at least about 10% more creaminess to a foodstuff in comparison to the creaminess induced within foodstuffs incorporating a comparable amount of tagatose alone.

8. A foodstuff according to claim 7, wherein said fat replacement composition is present within said foodstuff in an amount ranging from about 0.2 to 5.0 weight percent, bowfs.

9. A foodstuff according to claim 7, wherein said tagatose is present within said fat replacement composition in an amount ranging from abut 15 to 75 weight percent, bowrfc.

10. A foodstuff according to claim 7, wherein said indigestible oligosaccharide is present within said fat replacement composition in an amount ranging from about 25 to 85 weight percent, bowrfc.

11. A foodstuff according to claim 7, wherein said indigestible oligosaccharide is fructooligosaccharide.

12. A foodstuff according to claim 11, wherein said fructooligosaccharide is at least one of either inulin or oligofructose.

13. A foodstuff according to claim 7, further comprising at least one high intensity sweetener.

14. A foodstuff according to claim 13, wherein said high intensity sweetener comprises at least one member selected from the group consisting of acesulfame-K, aspartame, acesulfame-aspartame salt, cyclamate, saccharine, sucralose, NHDC, thaumatin, stevioside, neotame and brazzein.

15. A foodstuff according to claim 7, wherein said foodstuff is a dairy product.

16. A method of preparing a reduced calorie foodstuff, said method comprising
providing a reduced fat foodstuff and
incorporating an effective amount of a fat replacement composition comprising tagatose and at least one indigestible oligosaccharide,
said fat replacement composition providing at least about 10% more creaminess to a foodstuff in comparison to the creaminess induced within foodstuffs incorporating a comparable amount of tagatose alone.

17. A method according to claim 16, wherein said fat replacement composition is present within said foodstuff in an amount ranging from about 0.2 to 5.0 weight percent, bowfs.

18. A method according to claim 16, wherein said tagatose is present in said fat replacement composition an amount ranging from about 15 to 75 weight percent, bowrfc, and said indigestible oligosaccharide is present in said fat replacement composition in an amount ranging from about 25 to 85 weight percent, bowrfc.

19. A method according to claim 16, further comprising incorporating at least one high intensity sweetener.

20. A method according to claim 19, wherein said high intensity sweetener comprises at least one member selected from the group consisting of acesulfame-K, aspartame, acesulfame-aspartame salt, cyclamate, saccharine, sucralose, NHDC, thaumatin, stevioside, neotame and brazzein.
